(19) United States
(12) Patent Application Publication
(10) Pub. No.: US 2026/0190031 A1
(43) Pub. Date: Jul. 2, 2026

(54) DATA COLLECTION SYSTEM

(71) Applicant: NIPPON TELEGRAPH AND TELEPHONE CORPORATION, Tokyo (JP)

(72) Inventors: Shinya TAMAKI, Musashino-shi, Tokyo (JP); Tomohiro TANIGUCHI, Musashino-shi, Tokyo (JP); Ryota SHIINA, Musashino-shi, Tokyo (JP)

(73) Assignee: NIPPON TELEGRAPH AND TELEPHONE CORPORATION, Tokyo (JP)

(21) Appl. No.: 19/129,374

(22) PCT Filed: Dec. 8, 2022
(86) PCT No.: PCT/JP2022/045216

§ 371 Date: May 13, 2025

(51) Int. Cl. H04W 52/02; H04W 8/24

(52) U.S. Cl. CPC H04W 52/0235; H04W 8/24

(57) ABSTRACT

An object of the present disclosure is to enable collection of data at low cost from sensor terminals dispersedly deployed in a wide area.

The present disclosure is a data collection system that collects data from a plurality of terminals, a mobile network apparatus delivers an activation signal for activating the plurality of terminals from a sleep state and receives a layer 2 communication frame transmitted from the plurality of terminals, and the plurality of terminals, when receiving the activation signal, transmits preset information to the mobile network apparatus using an extension area of a layer 2 communication protocol.

### TECHNICAL FIELD

The present disclosure relates to collection of sensing data in the Internet of things (IoT).

### BACKGROUND ART

Network configuration information and device information about a terminal and a device are acquired with a lightweight communication protocol that is standardized and does not require high performance. For example, Non Patent Literature 1 reports a method using a link layer discovery protocol ((LLDP), see, for example, Non Patent Literature 3).

In IoT, it is necessary to network a large number of sensor terminals and collect data (sensing data) generated by the sensor terminals. In addition, in data utilization in IoT, importance of not only sensing data itself generated by a sensor terminal but also data related to sensing data called metadata has been reported (Non Patent Literature 2 and the like), and it is expected that a user can safely and easily utilize the sensing data by acquiring and distributing the sensing data and the metadata together. For example, when the LLDP disclosed in Non Patent Literature 1 is used, metadata (device information) such as a manufacturer name and a model number related to sensing data can be collected with an economical system configuration.

### CITATION LIST

### Non Patent Literature

Non Patent Literature 1: Yoshiyuki Mihara, Takefumi Yamazaki, Manabu Okamoto, Atsushi Sato, “Designing HTIP which Identifies Home Network Topology and Applying HTIP to a Troubleshooting Application”, Journal of the Information Processing Society of Japan, Consumer Device & System, Vol. 2, No. 3, pp. 34-45, Dec. 2012.
Non Patent Literature 2: Toshihiko Oda, Hiroshi Imai, Takeshi Naito, Hajime Takebayashi, “An Approach of Defining, Generating and Utilizing Metadata for Sensing Data Trading Market”, 2018 National Convention of the Society of Artificial Intelligence (32 times), June 2012.
Non Patent Literature 3: IEEE Std 802.1AB-2016, “IEEE Standard for Local and metropolitan area networks-Station and Media Access Control Connectivity Discovery”
Non Patent Literature 4: IEEE Std 802.11TM-2016 P.708 (Probe Request), P.712 (Probe Response)

### SUMMARY OF INVENTION

### Technical Problem

When sensor terminals are dispersedly deployed in a wide area and data can be collected from each sensor terminal only when necessary (when an abnormality occurs or the like), a wide variety of analyses can be performed. However, in order to construct a wireless communication system capable of covering a wide area, it is necessary to lay a wired communication system, and thus there is a problem that the cost of construction and maintenance thereof is high.

Therefore, an object of the present disclosure is to enable collection of data at low cost from sensor terminals dispersedly deployed in a wide area.

### Solution to Problem

A data collection system of the present disclosure is a data collection system that collects data from a plurality of terminals, and includes a terminal of the present disclosure and a mobile network apparatus of the present disclosure. The terminal and the mobile network apparatus of the present disclosure execute a data collection method of the present disclosure.

Specifically, when receiving an activation signal for activation from a sleep state from the mobile network apparatus, the terminal is activated, transmits preset information to the mobile network apparatus by using an extension area of a layer 2 communication protocol, and returns to the sleep state after transmitting the preset information.

Specifically, the mobile network apparatus delivers an activation signal for activating the terminal from the sleep state, and receives a layer 2 communication frame from the terminal activated by the activation signal.

Since the present disclosure uses a layer 2 communication frame, it is not necessary to establish a wireless communication connection. Thus, even a moving mobile network apparatus can collect preset information. Thus, the present disclosure can collect data at low cost from sensor terminals dispersedly deployed in a wide area without excessive network construction (mobile, local 5G, wired, etc.).

Here, the activation signal may be an analog signal that can be detected by a terminal during sleep. The analog signal may be at least one of sound, vibration, light, and radio waves.

In addition, the activation signal may be a radio signal conforming to IEEE 802.11ba.

In addition, the preset information may include at least one of a presence notification, a state notification, and an abnormality notification of the own apparatus.

Note that the above-described disclosures can be combined in any possible manner.

### Advantageous Effects of Invention

The present disclosure can enable collection of data at low cost from sensor terminals dispersedly deployed in a wide area.

### BRIEF DESCRIPTION OF DRAWINGS

FIG. 1 is a diagram describing a data collection system according to the present disclosure.

FIG. 2 is a diagram describing a terminal of the data collection system according to the present disclosure.

FIG. 3 is a diagram describing a management node of the data collection system according to the present disclosure.

FIG. 4 is a diagram describing a frame transmitted from a terminal to a management node.

FIG. 5 is an arrangement example of terminals according to the present disclosure.

FIG. 6 is a system configuration example according to the present disclosure.

FIG. 7 illustrates an example of an operation of a sensor terminal.

FIG. 8 illustrates an example of an operation of the data collection system according to the present disclosure.

### DESCRIPTION OF EMBODIMENTS

Embodiments of the present invention will be described with reference to the accompanying drawings. The embodiments to be described below are examples of the present invention, and the present invention is not limited to the embodiments to be described below. Note that components having the same reference numerals in the present description and the drawings indicate the same components.

### First Embodiment

In the present embodiment, a basic configuration of a data collection system will be described.

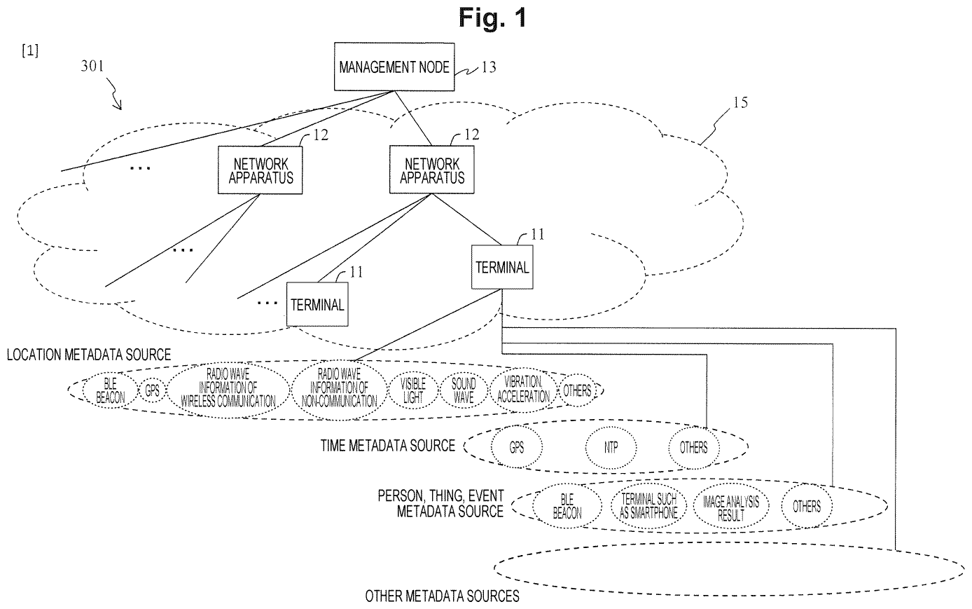

FIG. 1 is a diagram describing a data collection system 301 of the present embodiment. The data collection system 301 is a data collection system that performs communication from a terminal 11 to a network apparatus 12 by using an extension area of a standardized communication protocol (LLDP, HTIP, IEEE 802.11, or the like), in which
the terminal 11 stores sensing data detected by a sensor device in an area different from an area for storing metadata in a frame defined by the communication protocol, and sends the frame to the network apparatus 12,
the network apparatus 12 transfers the frame to a management node 13, and
the management node 13 stores the sensing data and the metadata in association with each other on the basis of information for identifying the terminal 11 described in the frame.

A data collection network 15 is a network that connects the terminal 11 existing in a specific range and the management node 13. The data collection network 15 is, for example, a local area network (LAN), a field area network (FAN), or an IoT area network. In the same data collection network 15, there may be a plurality of terminals 11 of a single type, or there may be terminals 11 of a plurality of types.

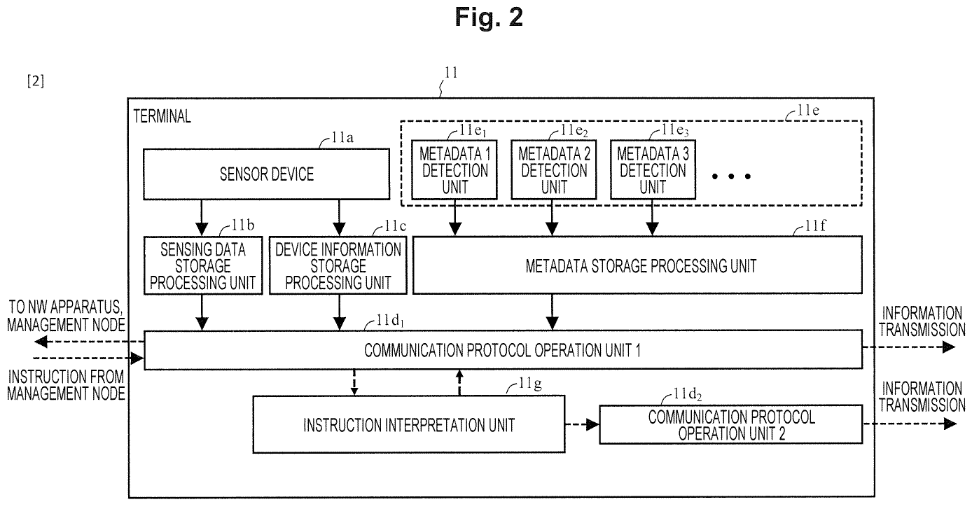

FIG. 2 is a diagram describing the terminal 11.

The terminal 11 is, for example, an IoT sensor terminal, performs sensing regarding an object to be observed, and generates sensing data. The terminal 11 includes a sensor device 11a, a sensing data storage processing unit 11b, a device information storage processing unit 11c, a communication protocol operation unit 11d₁, metadata detection units (11e₁, 11e₂, 11e₃, . . . ) , and a metadata storage processing unit 11f.

The sensor device 11a performs sensing regarding an object to be observed and acquires sensing data (main data). The sensing data is, for example, temperature, image, acceleration, sound, light, CO2, or the like.

The device information storage processing unit 11c collects device information of the object to be observed (for example, a manufacturer name, a model name, a model number, or the like of the device) and stores the information at a predetermined position of a frame (area that can be used for unique applications, such as an “extension area” or an “optional area” defined by the protocol).

The sensing data storage processing unit 11b stores the sensing data from the sensor device 11a at a predetermined position of a frame (such as a payload portion defined by protocol). The sensing data storage processing unit 11b may convert the sensing data into a certain shortened code and store the shortened code, or divide the sensing data into a plurality of frames and store (fragment) the frames so as to conform to the form/restriction of the unique extension area of the frame, and store the processed sensing data in the frame.

The sensing data storage processing unit 11b can arbitrarily set a storage timing at which the sensing data is stored in the frame. For example, the storage timing may be set such that the sensing data is stored every time when the sensing data is updated, or the sensing data may be stored not sequentially but at a timing at which the sensing data is accumulated for a certain period of time. In addition, in a case where the sensing data is accumulated for a certain period of time, the sensing data storage processing unit 11b may store a record (log) thereof or a result of specific calculation/statistical processing in the frame.

The type and storage timing of the sensing data to be stored in the frame may be fixed or vary. The type and storage timing of the sensing data may be dynamically changed according to determination by the terminal 11 itself and an instruction from the management node 13.

In addition, a transmission cycle of the frame may also be fixed or vary. The transmission cycle of the frame may be dynamically changed according to determination by the terminal 11 itself and an instruction from the management node 13.

The metadata detection unit 11e acquires information other than the device information (metadata). The information other than the device information is, for example, position information, time information, person, thing, or event information, and other information of the detection target. However, the present invention does not limit the information other than the device information to these pieces of information. In order to acquire these pieces of information, the metadata detection unit 11e includes a position information detection unit 11e₁, a time detection unit 11e₂, a person, thing, event detection unit 11e₃, and other detection units.

The position information detection unit 11e₁ is, for example, a GPS, an acceleration sensor, a gyro sensor, or an RSSI receiver such as a Wi-Fi signal or a Bluetooth low energy (BLE) beacon signal. Then, location metadata detected by the position information detection unit 11e₁ is a GPS signal, a BLE beacon signal, radio wave information of wireless communication, radio wave information of ; non-communication (television, radio, radio clock, other noise, or the like), power information, visible light information, sound wave information, vibration information, acceleration information, and information regarding a position acquired from another location metadata source.

The time detection unit 11e₂ is, for example, an information receiver from a GPS or a network time protocol (NTP). Then, time metadata detected by the time detection unit 11e₂ is a GPS signal, information from an NTP, and information regarding a time acquired from another time metadata source.

The person, thing, event detection unit 11e₃ is a receiver that receives information from a BLE beacon (carried by a person) or a smartphone carried by a person or information from an image analysis result, for example. Person, thing, or event metadata detected by the person, thing, event detection unit 11e₃ is a BLE beacon carried by a person, information from a smartphone carried by a person, information from an image analysis result, or information regarding a person, thing, or event acquired from another current event metadata source.

Examples of the metadata detected by the other detection units include information regarding a network configuration of the data collection network 15.

Note that the metadata detection unit 11e may detect all of a plurality of detection targets or may detect any one of the detection targets.

The metadata storage processing unit 11f stores the data detected by the metadata detection unit 11e as metadata in an extension area or an optional area in a frame set by the communication protocol. For example, the metadata storage processing unit 11f can store the metadata in a control-system frame of the IEEE 804.11 wireless LAN. Specifically, various metadata are stored in a “Vendor Specific” area, which is an extension area of a Probe Request frame. Alternatively, various metadata are stored in a “Vendor Specific” area, which is an extension area of a Probe Response frame.

The metadata storage processing unit 11f may convert the metadata into a certain shortened code and store the shortened code, or divide the metadata into a plurality of frames and store (fragment) the frames so as to conform to the form/restriction of the unique extension area of the frame, and store the processed metadata in the frame.

The metadata storage processing unit 11f can arbitrarily set a storage timing at which the metadata is stored in the frame. For example, the storage timing may be set such that the metadata is stored every time when the metadata is updated, or the metadata may be stored not sequentially but at a timing at which the metadata is accumulated for a certain period of time. In addition, in a case where the metadata is accumulated for a certain period of time, the metadata storage processing unit 11f may store a record (log) thereof or a result of specific calculation/statistical processing in the frame.

The type and storage timing of the metadata to be stored in the frame may be fixed or vary. The type and storage timing of the metadata may be dynamically changed according to determination by the terminal 11 itself and an instruction from the management node 13.

The communication protocol operation unit 11d₁, transmits a frame in which the sensing data and the device information are stored in a predetermined area and the metadata is stored in the extension area or the optional area to the network apparatus 12 using a lightweight and standardized communication protocol such as LLDP or home network topology identifying protocol (HTIP). Note that the communication protocol of the frame in which the sensing data is stored and the communication protocol of the frame in which the device information is stored may be the same or different. In the latter case, the metadata storage processing unit 11f may store the metadata in the frame of any one of the communication protocols (the frame in which the sensing data is stored or the frame in which the device information is stored), or may store the metadata in the frames of both communication protocols (the frame in which the sensing data is stored and the frame in which the device information is stored).

Further, the terminal 11 also has a function of operating in accordance with an instruction from the management node 13 or the like. Specifically, the terminal 11 includes an instruction interpretation unit 11g, and performs information transmission, in a case where the BLE beacon signal or the metadata information (information to be transmitted, radio wave intensity, sending frequency, and the like) transmitted by the terminal itself is changed, on information to the outside according to the instruction from the management node 13. In a case where information transmission is performed using the same protocol as in the communication with the network apparatus 12, the communication protocol operation unit 11d₁ is operated. In a case where information transmission is performed using a protocol different from that in the communication with the network apparatus 12, a communication protocol operation unit 11d₂ is provided in addition to the communication protocol operation unit 11d₁, and the communication protocol operation unit 11d₂ is operated.

Note that a case where the terminal 11 itself is a beacon signal source for another terminal to grasp metadata is also included. For example, the terminal 11 may be a beacon signal source for identifying location metadata, or may be a beacon terminal carried by an operator to identify an approaching person.

The network apparatus 12 is, for example, an apparatus such as a network switch, a wireless access point, or a wireless repeater. The network apparatus 12 sends a frame group uploaded from a lower data collection network 15 to the management node 13 as it is.

Here, the network apparatus 12 may include a processing part for the metadata included in the terminal 11 (the metadata detection unit 11e and the metadata storage processing unit 11f). Even in a case where the network apparatus 12 does not include the sensor device 11a, the network apparatus 12 can additionally attach unique information such as its own MAC address and metadata such as a connection port to the frame transmitted from the terminal 11 and transfer the frame to the management node 13, or sends the frame to the management node 13 together with its own identifier and the like.

When the network apparatus 12 includes the processing part for the metadata, the logical connection from the management node 13 to the terminal 11 can be grasped, and a more accurate logical/physical network management map can be created.

That is, even when the network apparatus 12 is a network switch (switching hub), a wireless repeater, or the like that does not have layer 3 or higher functions, since the present technology is performed in layer 2, it is possible to manage/grasp connection of network devices including the network apparatus 12.

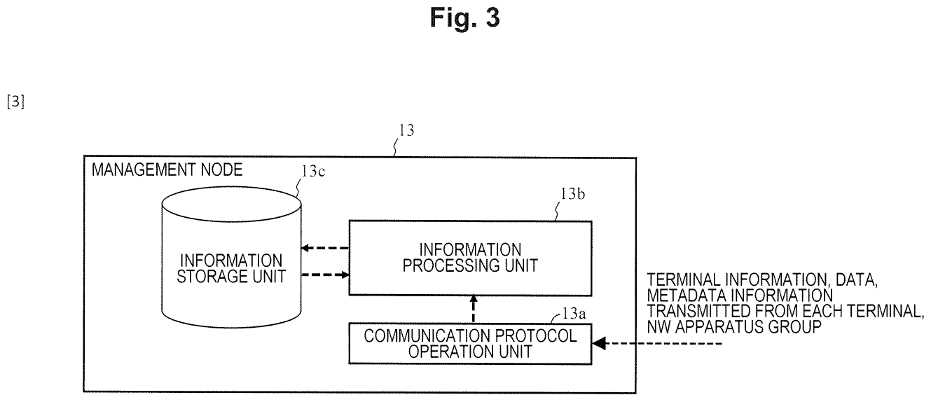

FIG. 3 is a diagram describing the management node 13. The management node 13 includes a communication protocol operation unit 13a, an information processing unit 13b, and an information storage unit 13c. The management node 13 extracts information from the frame passed from the network apparatus 12, stores the information, and uses the information for analysis. In particular, the management node 13 is characterized by having a function of storing a combination of two or more pieces of collected information in the information storage unit 13c.

The communication protocol operation unit 13a receives a frame in which the sensing data or the metadata from the terminal 11 or the network apparatus 12 is stored. The information processing unit 13b extracts the sensing data, the device information, and the metadata described below from the received frame, and organizes these in the information storage unit 13c on the basis of information for identifying the individual terminal 11 (for example, MAC address).
(1) Physical information of the terminal (information such as characteristics of a housing, image information, information on an attached label, a target pointed by the operator's finger, and a target of the operator's line of sight)
(2) Identifier of the terminal on a logical network (MAC address, UUID, or the like)
(3) Main data (sensing data such as temperature, image, acceleration, sound, light, or CO2).
(4) Various metadata (data such as location, time, person, thing, or event) For example, the management node 13 refers to metadata regarding location, and stores main data acquired at the same location or in a certain area in the format of [location metadata, main data].

### [Supplement]

The location metadata will be supplemented.

Like GPS information, there is a case where metadata is direct location metadata at the time point of sensing by the terminal 11. On the other hand, at the time point when a signal, visible light, or sound information from a BLE beacon is sensed by the terminal 11 and sent as metadata, whether or not it is location information is not determined, and the management node 13 may recognize/grasp the metadata as location metadata.

### [End of Supplement]

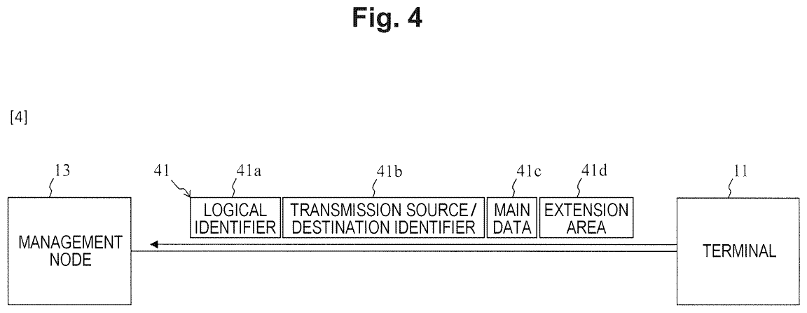

FIG. 4 is a diagram describing a frame 41 transmitted from the terminal 11 to the management node 13. In FIG. 4, description of the network apparatus 12 is omitted. The frame 41 is a layer 2 communication frame such as an Ethernet (registered trademark) frame or a Wi-Fi communication frame. The frame 41 includes a logical identifier 41a of a communication device such as a MAC address, an identifier 41b of a transmission source or destination such as an IP address, an area 41c in which sensing data such as temperature or an image is stored, and an extension area 41d in which metadata is stored. Among these, the identifier 41b and the area 41c are layer 3 communication packets.

For example, the management node 13 combines the MAC address of the logical identifier 41a, and the location metadata of the extension area 41d to associate them as [MAC address, location metadata], and combines the MAC address of the logical identifier 41a and installer metadata of the extension area 41d to associate them as [MAC address, installer metadata], and organize them in the information storage unit 13c.

As described above, the data collection system 301 can acquire the network configuration information, the device information, the sensing data, and the metadata of the terminal and the device using a communication protocol that does not require high performance.

### Second Embodiment

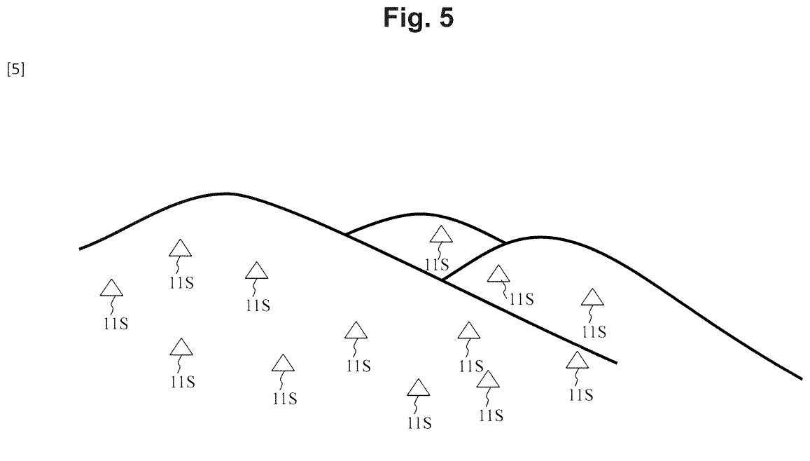

FIG. 5 is an arrangement example of terminals of the present embodiment. In the present embodiment, a plurality of sensor terminals 11S is dispersedly deployed in a wide area. For example, they are dispersedly arranged in an area of a size that cannot be covered by fixed access points that are fixed network apparatuses, such as those scattered in a mountain area. Note that the area where the sensor terminals 11S of the present disclosure are dispersedly deployed is not limited to a mountain area, but may be any area such as on a railway track.

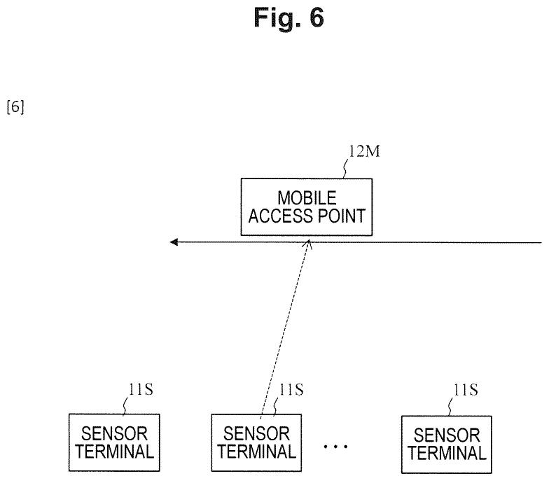

FIG. 6 is a system configuration example of the present embodiment. The data collection system of the present embodiment includes a plurality of sensor terminals 11S and a mobile access point 12M that is a mobile network apparatus, and executes a data collection method of the present embodiment.

As the moving means of the mobile access point 12M, any means that can move to a position where layer 2 communication with each sensor terminal 11S is possible can be adopted, and the mobile access point may travel on the ground, or may be capable of navigating in the air, on the sea, or under the sea.

The data collection method of the present embodiment is a data collection method for collecting data from the plurality of sensor terminals 11S, in which
the mobile access point 12M delivers an activation signal for activating the plurality of sensor terminals 11S from a sleep state,
the sensor terminal 11S having received the activation signal among the plurality of sensor terminals 11S transmits preset information to the mobile access point 12M using the extension area of the layer 2 communication protocol, and
the mobile access point 12M receives layer 2 communication frames transmitted from the plurality of sensor terminals 11S.

Since the sensor terminals 11S are dispersedly deployed in a wide area, power management is difficult. Therefore, the sensor terminals 11S is required to normally sleep due to a supply power problem. In the case of a system in which the sensor terminal 11S is activated from sleep and randomly sends data/metadata, power consumption of the sensor terminal 11S is wasted when the mobile access point 12M is not in the vicinity. Therefore, each sensor terminal 11S is activated from sleep when the mobile access point 12M approaches.

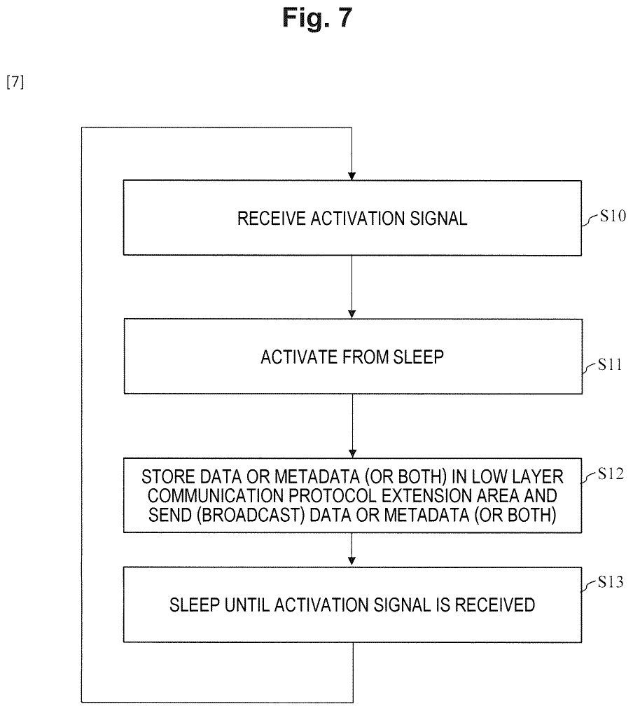

FIG. 7 illustrates an example of an operation of the sensor terminal 11S. When receiving an activation signal from the mobile access point 12M (S10), the sensor terminal 11S is activated from sleep (S11), issues (broadcasts) preset information (S12), and sleeps again (S13). By repeating this cycle, the sensor terminal 11S can send necessary information while saving power.

In step S11, for sensing the approach of the mobile access point 12M in each sensor terminal 11S, any analog signal that can be detected by the sensor device (reference sign 11a illustrated in FIG. 2) and the metadata detection unit (reference sign 11e illustrated in FIG. 2) provided in each sensor terminal 11S can be used. The analog signal may be any signal such as sound, vibration, light, or radio wave as long as the signal can be sensed even when the sensor terminal 11S is in a sleep state.

Issuance of the preset information in step S12 is performed using a layer 2 communication frame such as an Ethernet (registered trademark) frame or a Wi-Fi communication frame illustrated in FIG. 4. Specifically, the sensor terminal 11S stores the information to be transmitted in the extension area 41d illustrated in FIG. 4. By using such low-layer communication, information from the sensor terminals 11S dispersedly deployed in a wide area can be efficiently collected during high-speed movement.

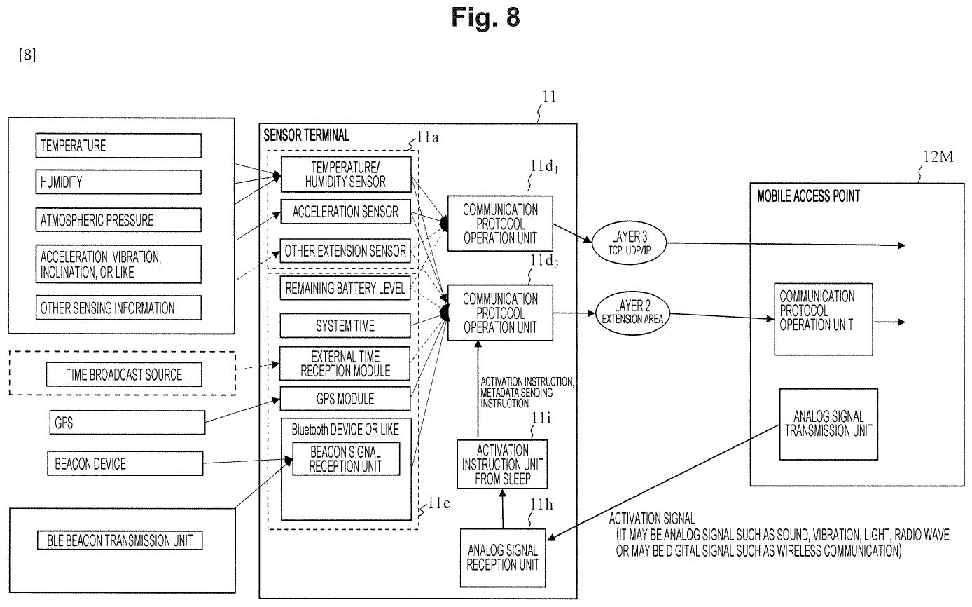

FIG. 8 illustrates an example of an operation of the data collection system. The mobile access point 12M delivers an activation signal capable of sensing the approach of the mobile access point 12M in each sensor terminal 11S to each sensor terminal 11S during movement and navigation. The delivery of the activation signal may be periodically transmitted, or may be transmitted after recognizing the presence of the terminal based on an image analysis result or the like. The activation signal is a broadcast signal delivered to an unspecified sensor terminal 11S, and may be an analog signal or a radio signal for activation defined by a protocol such as a radio signal conforming to IEEE 802.11ba.

When an analog signal reception unit 11h of each sensor terminal 11S senses the activation signal during sleep, an activation instruction unit 11i issues a metadata sending instruction together with an activation instruction. As a result, each sensor terminal 11S transitions from the sleep state to the activated state. A communication protocol operation unit 11d₃ transmits preset information to the mobile access point 12M using the extension area of a layer 2 communication protocol.

In the present embodiment, since a layer 2 communication protocol is used, there is no need for connection with a communication destination, authentication, or the like. Thus, each sensor terminal 11S can send the metadata immediately after activation.

Here, when the mobile access point 12M moves at a high speed, the sensor terminal 11S can communicate with the mobile access point 12M for a short time. Therefore, the information transmitted from the sensor terminal 11S does not include sensing data, and is limited to information in which the amount of data receivable by the mobile access point 12M is set.

For example, the preset information transmitted by the sensor terminal 11S can be, for example, “presence notification” or: “state notification” of the sensor terminal 11S, “abnormality notification” for informing abnormality of the sensor terminal 11S, and arbitrary data or metadata that can be acquired by the sensor terminal 11S. As described above, according to the present embodiment, data can be efficiently collected even by the mobile access point 12M moving at a high speed through data collection utilizing a low-layer communication protocol extension area.

Note that the preset information transmitted by the sensor terminal 11S may be information for temporarily staying and requesting data collection. In this case, in step S12, the communication protocol operation unit 11d₁ can transmit the sensing data to the mobile access point 12M.

In the present embodiment, since a layer 2 communication protocol is used, the mobile access point 12M can, during movement and navigation, quickly receive the metadata sent from each sensor terminal 11S with a low delay while moving and navigating. Thus, the present embodiment can enable collection of data at low cost from the sensor terminals 11S dispersedly deployed in a wide area.

### Other Embodiments

The sensor terminals 11S and the mobile access point 12M described above can also be implemented with a computer and a program, and the program can be recorded on a recording medium or provided through a network.

### REFERENCE SIGNS LIST

11 Sensor terminal
11a Sensor device
11b Sensing data storage unit
11c Device information storage unit
11d Protocol operation unit
11e Metadata detection unit
11h Analog signal reception unit
11i Activation instruction unit
12 Data collection unit
12a Protocol operation unit
12b Collected data processing unit
12c Data batch transmission unit
13 Data analysis unit
15 Data collection network
301, 302 Data collection system

1. A terminal that
is activated when receiving an activation signal for activation from a sleep state from a mobile network apparatus,
transmits preset information to the mobile network apparatus by using an extension area of a layer 2 communication protocol, and
returns to a sleep state after transmitting the preset information.

2. The terminal according to claim 1, wherein the preset information includes at least one of a presence notification, a state notification, and an abnormality notification of an own apparatus.

3. A mobile network apparatus that
delivers an activation signal for activating a terminal from a sleep state, and
receives a layer 2 communication frame from the terminal activated by the activation signal.

4. The mobile network apparatus according to claim 3, wherein the activation signal is an analog signal detectable by the terminal during sleep or a radio signal conforming to IEEE 802.11ba.

5. The mobile network apparatus according to claim 4, wherein the analog signal is at least one of sound, vibration, light, and radio waves.

6. (canceled)

7. A method wherein a terminal
is activated when receiving an activation signal for activation from a sleep state from a mobile network apparatus,
transmits preset information to the mobile network apparatus by using an extension area of a layer 2 communication protocol, and
returns to a sleep state after transmitting the preset information.

8. (canceled)
